(19) United States
(12) Patent Application Publication
(10) Pub. No.: US 2006/0239547 A1
(43) Pub. Date: Oct. 26, 2006

(54) Use of optical skin measurements to determine cosmetic skin properties

(76) Inventors: M. Ries Robinson, Carlsbad, CA (US); Russell E. Abbink, Sandia Park, NM (US); Michael J. Haass, Albuquerque, NM (US)

Correspondence Address: V. Gerald Grafe, esq.;General Counsel, InLight Solutions, Inc., 800 Bradbury SE, Albuquerque, NM, 87106, US

(21) Appl. No.: 11/407,179

(22) Filed: Apr. 19, 2006

Related U.S. Application Data
(60) Provisional application No. 60/673,246, filed on Apr. 20, 2005.

(51) Int. Cl. G06K 9/00; G06K 9/46

(52) U.S. Cl. 382/162; 382/118; 382/190

(57) ABSTRACT

The present invention relates to the use of optical skin measurements to determine skin properties such as surface topography, hydration, elasticity, pigmentation intensity or uniformity, dermal thickness, dermal perfusion, presence or concentration or composition of oil on or near the surface, and apparent age of the skin. An apparatus according to the present invention can comprise a skin positioning system for positioning the skin relative to other parts of the apparatus. An illumination system, adapted to produce illumination radiation, can mount with the skin positioning system such that illumination radiation impinges on a first portion of the skin at a first determined angle thereto. A detection system can mount with the skin positioning system such that radiation from a second portion of the skin at a second determined angle therefrom impinges on the detector. An analysis system can receive information from the detection system, and determine one or more skin properties from the detected radiation and the illumination radiation.

### CROSS REFERENCES TO RELATED APPLICATIONS

This application claims the benefit of U.S. Provisional patent application 60/673,246, “Use of quantitative optical skin measurements to determine apparent age,” filed Apr. 20, 2005, incorporated herein by reference.

### TECHNICAL FIELD

The present invention relates to the use of optical skin measurements to determine skin properties such as surface topography, hydration, elasticity, pigmentation intensity or uniformity, dermal thickness, dermal perfusion, presence or concentration or composition of oil on or near the surface, and apparent age of the skin.

### BACKGROUND OF THE INVENTION

As humans age chronologically there are changes that inevitably take place in the appearance of the skin. Some of these changes, such as wrinkles, take place at the surface, while others are caused by changes in the subsurface structure. Current societal trends place a great emphasis on age and appearance of age. Topical agents are available that claim to reduce the effects of aging, or the appearance of the effects of aging. The selection of such topical agents is generally based on subjective feedback, e.g., salesperson interactions, reactions from others, and personal opinion. Objective feedback related to the effectiveness of such agents, or even the need for such agents, is scarce.

A currently-available system uses a multi-spectral imaging system to acquire a clear, multi-dimensional image of select facial areas. The system is marketed as providing to provide clinical measurement of surface and subsurface epidermal irregularities and pigment conditions. See, e.g., http:///www.theskincentermd.com/treatment/visia.htm. The system, however, can be inconvenient to use, and generally requires expert operation and interpretation of results. The system does not measure individual skin properties such as collagen or elasticity; rather, it generates a detailed photograph that an expert can then use in recommending skin care products.

Accordingly, there is a need for low cost methods and apparatuses that can provide quantitative information about skin properties of sufficient quality to guide skin care and treatment.

### SUMMARY OF THE INVENTION

The present invention provides methods and apparatuses for determining cosmetic skin properties from optical measurements of the skin. “Cosmetic skin properties” means any one or more of the following: surface topography of the skin; hydration of the skin; elasticity of the skin; pigmentation intensity or uniformity of the skin; dermal thickness; dermal perfusion; presence or concentration or composition of oil, collage, or elastin in the skin, or on or near the surface of the skin; and apparent age of the skin. An apparatus according to the present invention can comprise a skin positioning system for positioning the skin relative to other parts of the apparatus. An illumination system, adapted to produce illumination radiation, can mount with the skin positioning system such that illumination radiation impinges on a first portion of the skin at a first determined angle thereto. A detection system can mount with the skin positioning system such that radiation from a second portion of the skin at a second determined angle therefrom impinges on the detector. An analysis system can receive information from the detection system, and determine one or more skin properties from the detected radiation and the illumination radiation.

Some embodiments of the present invention provide for illumination radiation having a first polarization, and a detection system with enhanced sensitivity to a second polarization, either the same as the first polarization (e.g., to emphasize surface properties) or different from the first polarization (e.g., to emphasize subsurface properties). The differing polarization allows the detection system to detect light from various depths in the skin by preferentially detecting radiation that has interacted with some depth of the skin (rather than just reflected from the skin surface).

Some embodiments of the present invention provide for illumination radiation having a first polarization, and have a detection system that detects radiation at both the first polarization and the second polarization. Radiation detected at the first polarization (the detection system polarization matches the illumination radiation polarization) generally correlates with surface or shallow penetration into the skin; radiation detected at the second polarization (the detection system polarization does not match the illumination radiation polarization) generally correlates with relatively deeper penetration into the skin. The analysis system can then determine skin properties from the content, similarities, and differences of the two types of optical information.

Some embodiments of the present invention provide for illumination radiation having a first polarization and a second polarization, and have a detection system that detects radiation at the second polarization. Illumination radiation at the second polarization (where the detection system polarization matches the illumination radiation polarization) generally correlates with surface or shallow penetration into the skin; illumination radiation at the first polarization (where the detection system polarization does not match the illumination radiation polarization) generally correlates with relatively deeper penetration into the skin. The analysis system can then determine skin properties from the content, similarities, and differences of the two types of optical information.

Some embodiments of the present invention provide for the illumination system, the detection system, or both, to mount with the skin positioning system such that the angle formed by the path of radiation to or from the skin surface can have two or more values. Different illumination or detection angles can allow collection of additional information about the skin. Some embodiments combine different angles with different polarizations.

Some embodiments of the present invention comprise a tissue elasticity sensor, providing a direct measurement of tissue elasticity or additional information for analysis such as apparent skin age. A skin elasticity sensor according to the present invention can comprise a chamber adapted to sealingly engage a perimeter of a portion of the skin. A pressure reducing system can reduce the pressure in the chamber, pulling the skin surface up into the chamber. An illumination system and a detection system can mount with the chamber such that the skin pulled up into the chamber obstructs radiation traveling between the illumination and detection systems. The deformation of the skin can thus be measured. Various characteristics relative to the elasticity of the skin can be determined; e.g., the absolute deformation of the skin responsive to a determined pressure or range of pressures, the time for the skin to deform in response to a pressure change, and the time for the skin to return to its original conformation after deforming in response to a pressure change.

Some embodiments of the present invention comprise a tissue temperature sensor, providing a direct measurement of tissue temperature or additional information for analysis such as apparent skin age.

Some embodiments of the present invention provide a detection system comprising a linear array of detectors, and illumination having at least two colors. The detection system can provide information about the coloration or pigmentation intensity of the skin. The illumination system, the detection system, or both can be configured or moved to determine coloration of different portions of the skin, allowing analysis of pigmentation uniformity of the skin. Other embodiments can achieve similar performance with a detection system comprising a two dimensional array of detectors.

The advantages and features of novelty that characterize the present invention are pointed out with particularity in the claims annexed hereto and forming a part hereof. However, for a better understanding of the invention, its advantages, and the object obtained by its use, reference should be made to the drawings which form a further part hereof, and to the accompanying descriptive matter in which there are illustrated and described preferred embodiments of the present invention.

### BRIEF DESCRIPTION OF THE DRAWINGS

FIG. 1 is a schematic illustration of an example scatterometer according to the present invention.

FIG. 2 is a schematic illustration of an example scatterometer according to the present invention.

FIG. 3 is a schematic illustration of an example apparatus suited for determining skin hydration according to the present invention.

FIG. 4 is a schematic illustration of an example apparatus suited for measuring skin elasticity according to the present invention.

FIG. 5 is a schematic illustration of an example apparatus suited for measuring perfusion according to the present invention.

FIG. 6 is a schematic illustration of an example apparatus suited for measuring skin color properties according to the present invention.

FIG. 7 is a schematic illustration of an example apparatus suited for measuring skin color properties according to the present invention.

### DETAILED DESCRIPTION OF THE INVENTION

The present invention provides methods and apparatuses for determining cosmetic skin properties from optical measurements of the skin. “Cosmetic skin properties” means any one or more of the following: surface topography of the skin; hydration of the skin; elasticity of the skin; pigmentation intensity or uniformity of the skin; dermal thickness; dermal perfusion; presence or concentration or composition of oil, collage, or elastin in the skin, or on or near the surface of the skin; and apparent age of the skin. These skin characteristics can provide useful information alone or in combination. Surface topography is associated with fine lines, wrinkles, and roughness, which generally increase with age and exposure to ultraviolet light. Skin hydration is associated with water content in the surface and deeper layers, which can contribute to surface smoothness. Elasticity or firmness is associated with the ability of the skin to return to its normal shape after being stretched out of shape. Loss of elasticity can be manifested in large wrinkles and sagging. It can be affected by hydration and also can be a characteristic function of aging resulting from changes in the chemistry of the collagen and elastin structure of the skin. Pigmentation intensity and uniformity can be a property of the genetic information in the skin, and can change with age and with exposure to ultraviolet light. Dermal thickness and structure can change with age, for example the dermis can become thinner, and the interface between the dermis and the epidermis can become smoother with age (reducing the contact area between the dermis and the epidermis). Perfusion is associated with the supply of blood to the capillary bed in the skin, and can be affected by skin temperature, and can decrease with age and result in perceived skin color changes.

A number of skin properties affecting the visual perception of skin are correlated with age. Some of them can also be affected by environment and nutrition factors that lead to the visual perception of skin that is older than it really is. For example, dehydration, often a temporary state, can affect the elasticity or skin turgor, reducing its smoothness and ability to rebound from deformations. UV exposure can cause both temporary and long-term changes that affect pigmentation uniformity, elasticity, hydration and fine wrinkles.

Recognizing the correlation of many skin parameters with age allows, through a series of quantitative measurements of these parameters, an estimate of a person's chronological age, strictly based on this data. This apparent, or biological age can differ from a person's actual chronological age due to various environmental or health conditions. Comparing this apparent age with chronological age allows a simple quantitative measure of an individual person's skin condition relative to others of the same chronological age.

Although many skin parameters have been measured in great detail in laboratory studies there is no simple, low cost instrumentation that can measure a combination of skin parameters useful in determining apparent age in a non-laboratory environment such as the home or a store. Although data from low cost instruments may not necessarily be of the same accuracy as higher cost laboratory instruments it can be sufficient, after calibration, to provide useful data for a variety of purposes including, as examples, assessing or predicting the effects of various skin care products. The use of even simple instruments can substantially reduce the subjective nature of visual assessment alone and, at the same time, provide more insight into underlying causes of certain conditions.

The following examples of low cost methods for assessing skin parameters illustrate embodiments and examples consistent with the present invention. The present invention comprises variations, subsets, and combinations that will be apparent to those skilled in the art from reading of this specification or practice of the invention, even if not explicitly described herein.

Fine Lines and Wrinkles.

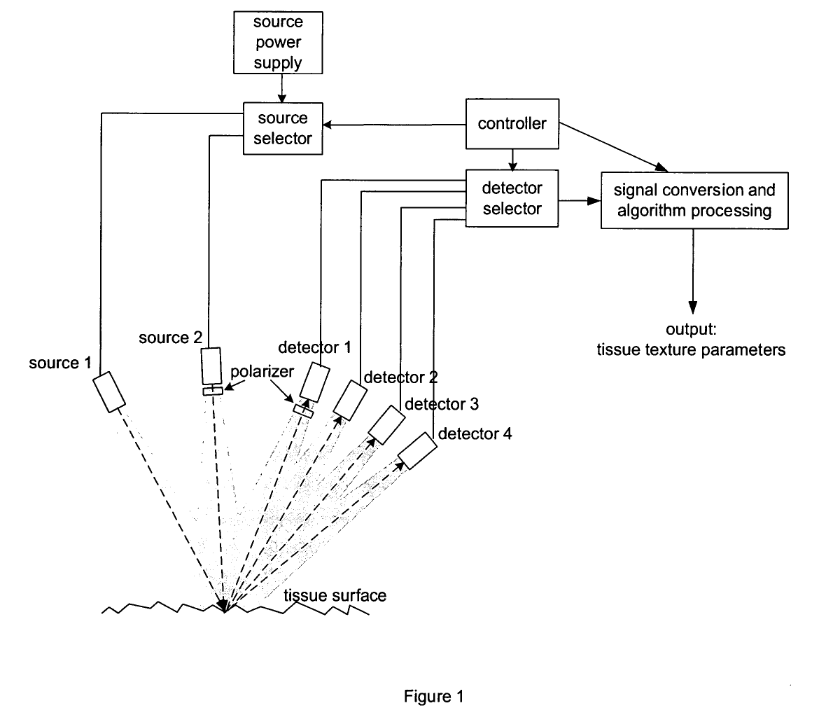

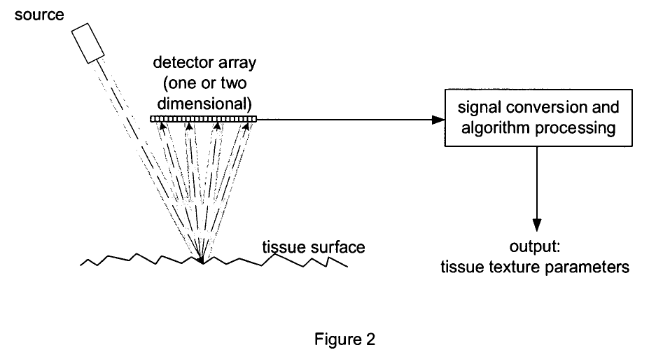

A laboratory quantification of fine lines and wrinkles can be obtained by obtaining a magnified stereoscopic image of the skin, sometimes aided by a contrast enhancing ink or dye, and then performing a statistical analysis of the number, length, and depth of lines in a given area using image-processing techniques on a computer. The cost of a simplified instrument of this type can be brought to a level attractive to the consumer by using a low cost CCD camera along with a specialized microcomputer and signal processing algorithms. The present invention provides a simpler instrument, which can be understood by examining the way light scatters from the tissue. The intensity of light scattering from the surface at various angles (soemtimes referred to as the bidirectional reflectance distribution function, or BRDF) is a function of the number and depth of surface features such as fine lines, wrinkles, and roughness. Adequate quantification of these parameters can be determined by correlating the measurements made with a simple scatterometer with those made by a more rigorous image processing method. A simple scatterometer is schematically illustrated in FIG. 1. It comprises one or more collimated or restricted angle light sources that can illuminate a small area of skin at various angles or polarizations. Incandescent lamps and light emitting diodes (LEDs) can be suitable for this purpose. One or more filters can be used to select desirable wavelength regions. One or more photodetectors can then collect the scattered light at another set of angles or relative polarizations. Digitization and processing of this information, for example with a simple microprocessor, can yield one or more parameters correlated with the skin surface topology. A refinement of this technique involves the use of linearly or circularly polarized light illumination and collection using parallel and crossed polarizers. This additional information allows separation into two categories: 1) surface scattered light from the fine lines and wrinkles, and 2) light scattered inside the tissue. By looking at the polarization state in more detail, e.g. by rotating the polarizer in front of a photodiode, information can be obtained about tissue properties at different depths. A variant of the scatterometer is schematically illustrated in FIG. 2. It includes a linear detector array, instead of a limited number of photodetectors, to collect light from a continuum of angles.

Hydration.

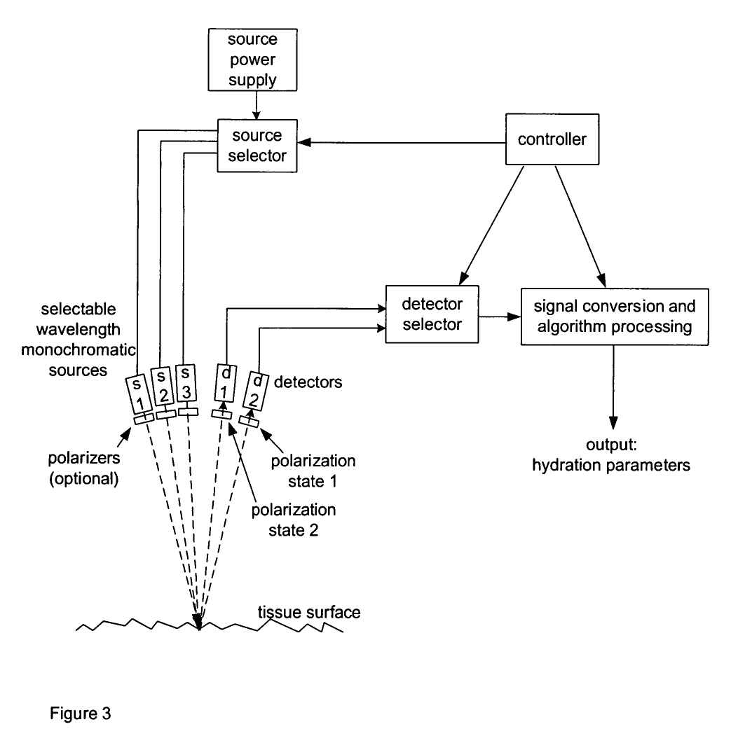

Skin water content can be measured with an instrument of the type illustrated schematically in FIG. 3. It can be considered as similar to the scatterometer described previously, but can use light at specific wavelengths corresponding to absorption bands of water, for example at 760 nm, 975 nm, 1450 nm and 1920 nm. By including sources at one or more of these wavelengths along with sources at non-absorbing wavelengths, the water content in the path can be quantitatively determined by examining the intensity ratio of absorbing vs. non-absorbing wavelengths. Near-surface hydration can be discriminated from subsurface hydration through the use of polarized light. Depth of penetration of the measurement can also be controlled by proper choice of wavelengths. For example, the two shortest wavelength absorption bands from the list above, will generally measure further into the tissue than the two longer wavelength bands listed. A low-cost indirect measure of surface moisture content, e.g. in the stratum corneum, can also be made by measuring the electrical resistance of the skin. Skin oiliness can be measured by the wavelength selection method, targeting wavelengths that are absorbed by the skin oils vs. those that are not.

Elasticity.

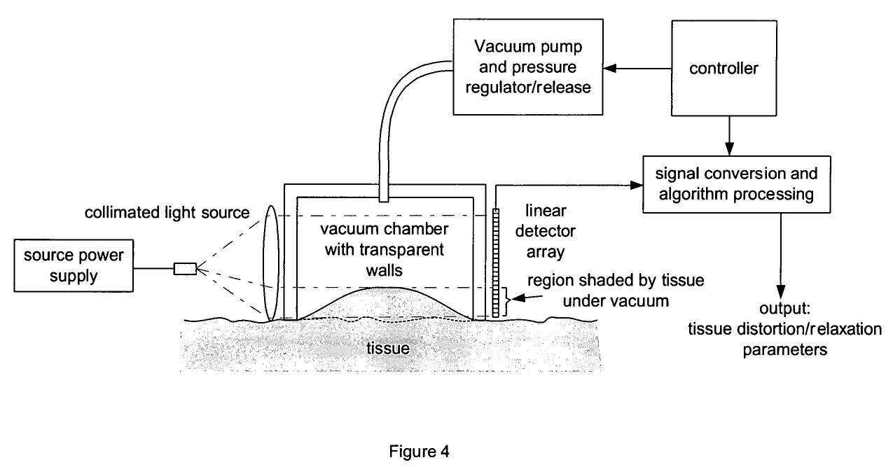

An apparatus for measuring skin elasticity is shown schematically in FIG. 4. It comprises a means of drawing a partial vacuum over a specific portion of the tissue to cause the tissue to bulge up in that area. For example a cylindrical tube can be used which is open on one end to place against the skin and closed on the other end. Vacuum can be applied through a port in the tube using a squeeze bulb or a small electric vacuum pump, along with a means, such as a pressure sensitive switch or valve, to set a specific vacuum level. A substantially collimated light source can be directed parallel to the relaxed skin surface and toward an array of photodetectors. The tissue bulged up by the vacuum then casts a shadow on the detector array, allowing the height of the bulge to be determined. This information can be used to examine the deflection of the tissue for a known pressure change and to measure the time required for the tissue to return to its normal undeflected state after the vacuum is released.

Perfusion.

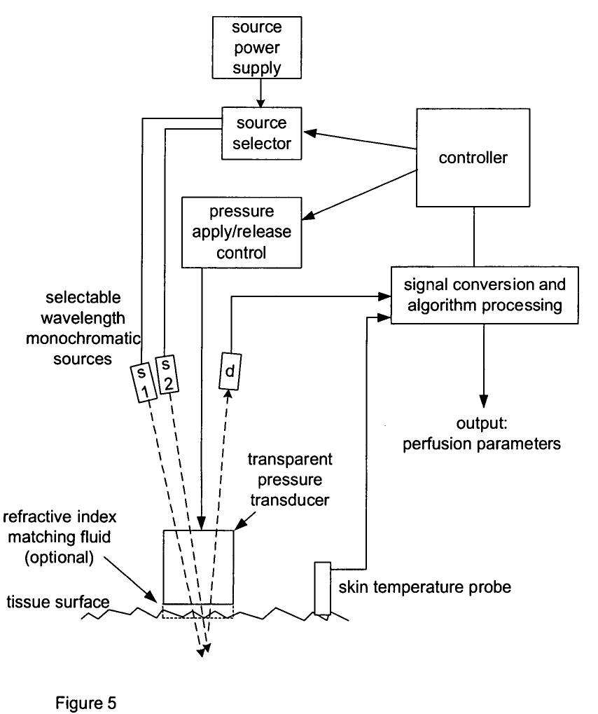

A measurement of perfusion can be made with an apparatus such as that illustrated schematically in FIG. 5. Light sources at two or more selected wavelengths (e.g. light emitting diodes) can be directed into the tissue, and a photodetector can collect the light scattered back from the tissue. At least one of the source wavelengths can be selected to be at a hemoglobin absorption wavelength (e.g. 580 nm) and another at a lesser-absorbing wavelength. A pressure transducer can be used to apply pressure to a small area of skin, forcing blood out of the capillaries in that region. When the pressure is released the blood will return to this region and the recovery time can be measured using the ratio of light intensity at the two wavelengths. The controller can rapidly switch between the sources and provides information to the processor to specify which source is being viewed at any moment in time. Alternatively, a single source covering all wavelengths of interest can be used in conjunction with two or more detectors with filters at the wavelengths of interest. By using a transparent pressure transducer the response can be continuously monitored during the application and release of pressure. A refractive index matching fluid can be applied at the skin/transducer interface to reduce surface reflections and allow better viewing of the sub surface capillary bed. A thermistor temperature sensor in contact with the skin can provide data for temperature correcting the results.

Skin Pigmentation Color and Uniformity.

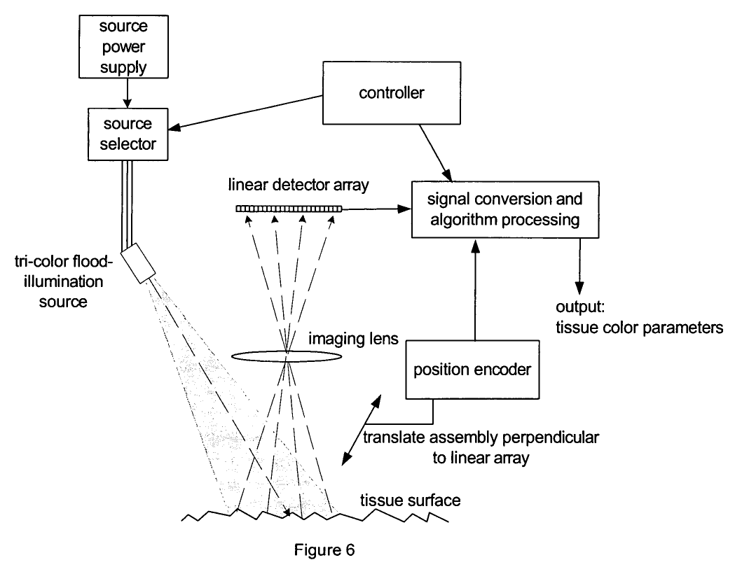

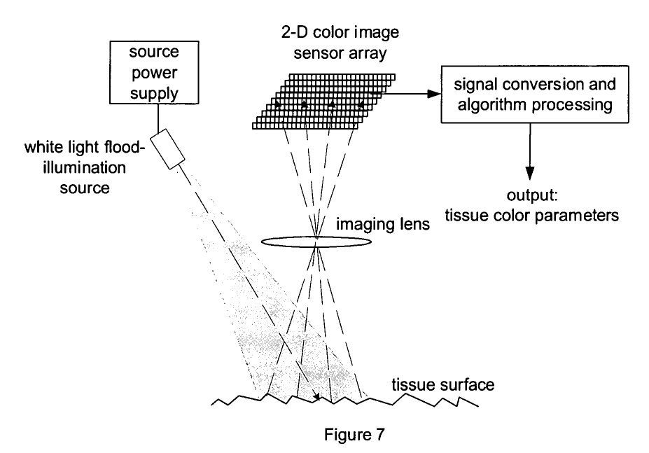

Two versions of a simple calorimeter are depicted schematically in FIGS. 6 and 7. The first comprises a color (two or more colors) tissue flood illumination source and a linear detector array with a lens to image the illuminated skin surface on the array. An example tri-color source can be three light emitting diodes (e.g. red, green, and blue) in a single package or in separate packages, multiplexed by the controller in a manner similar to that described for the perfusion monitor. Two-dimensional information can be obtained by scanning the device across the skin surface in the direction perpendicular to the axis of the detector array. This can be done manually. Position along the direction of travel can be determined either from a rolling encoder wheel or by processing surface texture information in a manner similar to that used by a computer optical mouse. In the second example embodiment (FIG. 7) a white light source can be used to flood-illuminate the skin and a color image detector array similar to that used in digital cameras can be used to collect a color image of the tissue. In both cases a relatively simple image-processing algorithm can be used to quantify skin color and color uniformity.

Other Example Embodiments.

The present invention can determine skin characteristics using any of a variety of optical systems, including as examples Fourier transform interferometer, grating spectrometer, linear variable filter array, Raman spectroscopic instrument, discrete wavelength detectors, and others known to those skilled in the art. The present invention in some embodiments can provide determination of skin characteristics at a large number of wavelengths, e.g., 100 or more (sometimes called “hyperspectral” measurement). In some embodiments the present invention can provide spatially resolved information, e.g., information about skin characteristics over subsets of a portion of tissue, or information about properties as a function of location within an image of tissue. The present invention, in some embodiments, can provide for comparison of properties between two or more regions of skin, e.g., two or more surface regions, two or more depths, or two or more volumes (such as the volumes beneath two surface regions).

The various apparatuses and measurements described above can be efficiently combined into a single apparatus, with the various measurements made using common elements of the apparatus, to provide an economical and expedient system for measuring cosmetic skin properties such as apparent age of skin.

What is claimed is:

1) An apparatus for determining one or more cosmetic skin properties, comprising:
a) A skin positioning system;
b) A illumination system, adapted to produce illumination radiation and mounted with the skin positioning system such that illumination radiation impinges on a first portion of the skin at a first determined angle thereto;
c) A detection system, mounted with the skin positioning system such that radiation from a second portion of the skin at a second determined angle therefrom impinges on the detector, where the second portion of the skin is the same as or different from the first portion of the skin;
d) An analysis system, adapted to determine one or more skin properties from the detected radiation and the illumination radiation.

2) An apparatus as in claim 1, wherein the light source produces illumination radiation having a first polarization, and wherein the detection system has greater sensitivity to radiation having a second polarization, different from the first polarization, than its sensitivity to radiation having the first polarization.

3) An apparatus as in claim 1, wherein the light source produces illumination radiation having a first polarization, and wherein the detection system produces a first signal responsive to detected radiation having the first polarization, and produces a second signal responsive to detected radiation having a second polarization, different from the first polarization.

4) An apparatus as in claim 1, wherein the light source produces illumination radiation having a first polarization, and illumination radiation having a second polarization, different from the first polarization, and wherein the detection system produces a first signal responsive to detected radiation having the first polarization emitted from the skin while the skin is illumined with radiation having the first polarization, and produces a second signal responsive to detected radiation having a first polarization emitted from the skin while the skin is illumined with radiation having the second polarization.

5) An apparatus as in claim 1, wherein the illumination system is mounted with the skin positioning system such that the illumination radiation impinges on the first portion of the skin at a first angle thereto, a second angle thereto, or a combination thereof.

6) An apparatus as in claim 1, wherein the detection system mounts with the skin positioning system such that radiation from a second portion of the skin at a first angle thereto, a second angle thereto, or a combination thereof, impinges on the detection system.

7) An apparatus as in claim 6, wherein the detector preferentially detects radiation having a first polarization when the radiation is at the first angle, and preferentially detects radiation having a second polarization when the radiation is at the second angle.

8) An apparatus as in claim 1, further comprising a tissue elasticity sensor, and wherein the analysis system is further responsive to the tissue elasticity sensor.

9) An apparatus as in claim 1, further comprising a skin temperature sensor, and wherein the analysis system is responsive to the skin temperature.

10) An apparatus as in claim 1, wherein
a) The detection system comprises a linear array of detectors;
b) The illumination radiation comprises radiation having at least two colors;
c) The first portion and the second portion of the skin substantially overlap;
d) And further comprising an imaging system that images the second portion of the skin onto the linear array of detectors;
e) And wherein the illumination system and the detection system mount with the skin positioning system such that the first portion of the skin, the second portion of the skin, or both, can be changed.

11) An apparatus as in claim 1, wherein
a) The detection system comprises a two dimensional array of detectors;
b) The illumination radiation comprises radiation having at least two colors;
c) The first portion and the second portion of the skin substantially overlap;
d) And further comprising an imaging system that images the second portion of the skin onto the linear array of detectors.

12) A skin elasticity sensor, comprising
a) A chamber adapted to sealingly engage the perimeter of a portion of the skin;
b) A pressure reducing system adapted to reduce the pressure in the chamber to a level below the pressure in the skin;
c) A light source mounted with the chamber such that light from the light source travels through the chamber substantially parallel to the skin surface;
d) A detector mounted with the chamber such that light from the light source impinges on the detector, and such that deformation of the skin in the chamber obstructs a portion of the light traveling between the light sources and the detector;
e) An analysis system for determining skin elasticity from the light detected by the detector.

13) A skin elasticity sensor as in claim 12, wherein the analysis system determines the total deformation of the skin responsive to the reduction in pressure in the chamber.

14) A skin elasticity sensor as in claim 12, wherein the analysis system determines the recovery from deformation of the skin responsive to varying reduction in pressure in the chamber.

15) An apparatus as in claim 1, further comprising a skin elasticity sensor as in claim 12.

16) An apparatus as in claim 1, wherein the light source produces illumination radiation having a first polarization, and wherein the detection system has greater sensitivity to radiation having the first polarization, than its sensitivity to radiation having the polarization other than the first polarization.

17) An apparatus as in claim 1, wherein the illumination system is mounted with the skin positioning system such that the illumination radiation impinges on the first portion of the skin at any of a plurality of angles thereto.

18) An apparatus as in claim 1, wherein the detection system mounts with the skin positioning system such that radiation from a second portion of the skin at any of a plurality of angles thereto impinges on the detection system.

19) An apparatus as in claim 1, wherein the first portion of the skin substantially overlaps the second portion of the skin.

20) An apparatus as in claim 1, wherein the first portion of the skin does not substantially overlap the second portion of the skin.
